(19) United States
(12) Patent Application Publication
(10) Pub. No.: US 2026/0136329 A1
(43) Pub. Date: May 14, 2026

(54) COMMUNICATION METHODS AND APPARATUSES FOR MEDIUM ACCESS CONTROL

(71) Applicant: GUANGDONG OPPO MOBILE TELECOMMUNICATIONS CORP., LTD., Dongguan (CN)

(72) Inventor: Yinan QI, Dongguan (CN)

(21) Appl. No.: 19/432,690

(22) Filed: Dec. 24, 2025

Related U.S. Application Data
(63) Continuation of application No. PCT/CN2023/105049, filed on Jun. 30, 2023.

(51) Int. Cl. H04W 64/00; H04W 74/0808; H04W 80/02

(52) U.S. Cl. CPC H04W 64/003; H04W 74/0808; H04W 80/02

(57) ABSTRACT

A communication method of medium access control includes determining, by an access point (AP), a medium access control associated with ambient power (AMP) devices based on a location information associated with the AMP devices, and transmitting, by the AP, the medium access control to at least one of the AMP devices. Another communication method of medium access control includes receiving, by at least one of ambient power (AMP) devices from an access point (AP), a medium access control associated with the AMP devices, wherein the medium access control is associated with a location information associated with the AMP devices, and performing, by the at least one of AMP devices, channel access based on the medium access control.

### CROSS-REFERENCE TO RELATED APPLICATION

This application is a continuation of International Application No. PCT/CN2023/105049 filed on June 30, 2023, the disclosure of which is hereby incorporated by reference in its entirety.

### BACKGROUND

In current massive deployment of ambient power (AMP) devices, even with group sectorization, there are massive AMP devices belonging to each sector group and collision can still easily happen. For example, AMP devices are expected to be deployed massively in some use cases, e.g., more than 3 per m² in a data center. In such a case, assuming 30 m coverage and 3 sectors, there could be approximately 3000 AMP devices within one sector. Even with group sectorization, such huge number of AMP devices could still cause severe collision issue, and a channel access efficiency is low.

Therefore, there is a need for communication methods and apparatuses of medium access control, which can improve the collision issue and/or the channel access efficiency.

### SUMMARY

The present disclosure relates to the field of communication technologies, and more particularly, to communication methods and apparatuses for medium access control, such as methods and apparatus of accurate location aware medium access for massive ambient power (AMP) devices.

An object of the present disclosure is to propose communication methods and apparatuses of medium access control, which can enhance a channel access efficiency, improve a collision issue, mitigate a hidden node issue, improve additional resource usage, and/or improve signaling overhead.

In a first aspect of the present disclosure, a communication method of medium access control includes determining, by an access point (AP), a medium access control associated with ambient power (AMP) devices based on a location information associated with the AMP devices, and transmitting, by the AP, the medium access control to at least one of the AMP devices.

In a second aspect of the present disclosure, an Access Point (AP) includes a memory; a transceiver; and a processor coupled to the memory and the transceiver. The processor is configured to execute computer-executable instructions stored in the memory to perform operations of: determining a medium access control associated with ambient power (AMP) devices based on a location information associated with the AMP devices; and transmitting, via the transceiver, the medium access control to at least one of the AMP devices.

In a third aspect of the present disclosure, an ambient power (AMP) device includes a memory; a transceiver; and a processor coupled to the memory and the transceiver. The processor is configured to execute computer-executable instructions stored in the memory to perform operations of: receiving, via the transceiver from an access point (AP), a medium access control associated with the AMP devices, wherein the medium access control is associated with a location information associated with the AMP devices; and performing channel access based on the medium access control.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic structural diagram of a group sectorization in institute of electrical and electronics engineers (IEEE) 802.11ah.

FIG. 2 is a schematic structural diagram of grouping based on a location information of ambient power (AMP) devices according to an embodiment of the present disclosure.

FIG. 3A a block diagram of group channel access in different time intervals including one group per time interval according to an embodiment of the present disclosure.

FIG. 3B is a block diagram of group channel access in different time intervals including multiple groups per time interval according to an embodiment of the present disclosure.

FIG. 4 is a block diagram of an access point (AP) according to an embodiment of the present disclosure.

FIG. 5 is a block diagram of an AP according to an embodiment of the present disclosure.

FIG. 6 is a flowchart illustrating a communication method of medium access control performed by an AP according to an embodiment of the present disclosure.

FIG. 7 is a block diagram of at least one AMP device according to an embodiment of the present disclosure.

FIG. 8 is a block diagram of at least one AMP device according to an embodiment of the present disclosure.

FIG. 9 is a flowchart illustrating a communication method of medium access control performed by at least one AMP device according to an embodiment of the present disclosure.

FIG. 10 is a flowchart illustrating a communication method of medium access control regarding signaling procedure according to an embodiment of the present disclosure.

FIG. 11 is schematic structural diagram of uplink orthogonal frequency-division multiple access (OFDMA) random access (UORA) in IEEE 802.11ax.

FIG. 12 is schematic structural diagram of uplink random access (URA) mechanism according to an embodiment of the present disclosure.

FIG. 13 is a block diagram of an example of a computing device according to an embodiment of the present disclosure.

FIG. 14 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Group Sectorization

The group sectorization mechanism is developed with an intent to address a hidden node issue which is especially more pronounced in dense long-range networks. During the association procedure, an access point (AP) assigns each associated station (STA) an identifier (ID) of a sector which the station belongs to. The AP divides time into sector intervals and at the start of each sector interval, the AP transmits a beamformed beacon to the sector which is allowed to access a channel during the sector interval. This alleviates a hidden node issue as all the stations belonging to the same sector can hear each other’s transmissions.

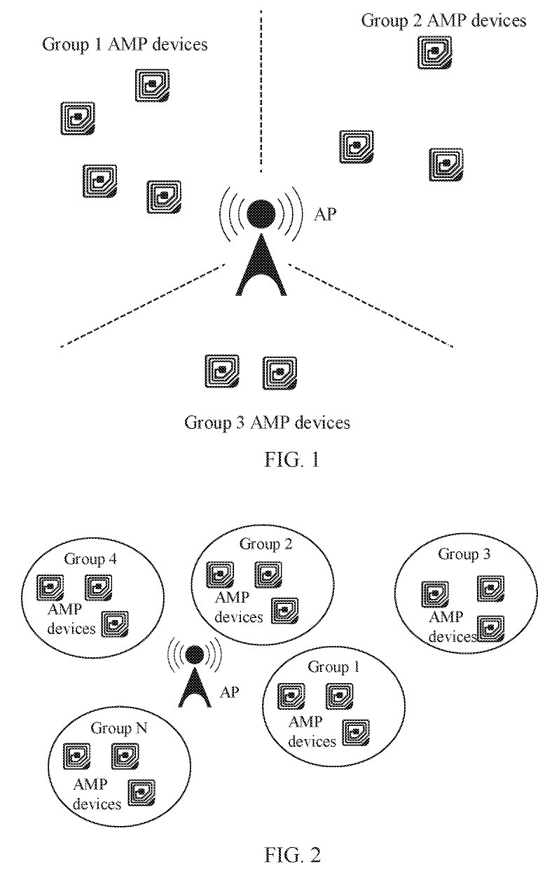

In institute of electrical and electronics engineers (IEEE) 802.11ah, group sectorization is proposed based on combined use of space and time-division multiplexing as illustrated in FIG. 1. An AP may divide the time into sector intervals. Each sector interval begins with a beamformed beacon, saying which sectors are allowed to access the channel during the sector interval. If a station (such as an ambient power (AMP) device) does not belong to the sector, it is forbidden to access the channel. For example, during time interval one, only group 1 AMP devices are allowed to access the channel, and group 2 and group 3 AMP devices are not allowed. By such space division multiplexing, collision can be avoided, and system throughput can be improved.

In addition, FIG. 1 illustrates that, the AP divides space into several spatial sectors. During association procedure, the station may obtain from the AP, an identifier (ID) of the sector which the station belongs to. However, considering massive deployment of ambient power (AMP) devices, even with group sectorization, there are massive AMP devices belonging to each sector group and collision can still easily happen.

In the current group sectorization in IEEE 802.11ah, the entire covered area by one AP is divided into sectors and each sector is covered by one beam of the AP. Considering the complexity and deployment cost of APs, especially the AMP APs which are expected to be deployed with higher density compared with the existing deployment, an antenna array of each AP is relatively simple with low cost. In this regard, the beam is wide and only very few sectors can be divided, e.g., 3 sectors similar to the cellular network deployment. Some of the APs may only support omni-directional transmission, i.e., no sectoring at all. However, AMP devices are expected to be deployed massively in some use cases, e.g., more than 3 per m² in a data center. In such a case, assuming 30 m coverage and 3 sectors, there could be approximately 3000 AMP devices within one sector. Even with sectorization, such huge number of AMP devices could still cause severe collision problem.

Therefore, there is a need for communication methods and apparatuses of medium access control, which can improve the collision issue and/or the channel access efficiency. Some embodiments of the present disclosure propose communication methods and apparatuses of medium access control, such as methods and apparatus of accurate location aware medium access for massive ambient power (AMP) devices, which can enhance a channel access efficiency, improve a collision issue, mitigate a hidden node issue, improve additional resource usage, and/or improve signaling overhead.

The at least one proposed solution, method, system, and apparatus of some embodiments of the present disclosure may be used for current and/or new/future standards regarding communication systems such as AMP tag based communication systems. Compatible products follow at least one proposed solution, method, system, and apparatus of some embodiments of the present disclosure. The proposed solution, method, system, and apparatus are widely used in AMP related products, AP related products, and/or communication systems. With the implementation of the at least one proposed solution, method, system, and apparatus of some embodiments of the present disclosure, at least one modification to methods and apparatus of location aware medium access for AMP devices are considered for standardizing.

### Location Aware Grouping Regarding AMP Devices

It is noticed that AMP devices share some common features as below:

In some examples, the exact location of AMP devices might be available to an AP, especially for the indoor case. In an internet of things (IoT) network, the main service provided by IoT devices my include data communication, e.g., sensor data reporting. For such network, positioning each IoT device and reporting such information to the AP may consume huge amount of system resources and cause dramatically increasing signaling overhead, thus leading to low efficiency. On the contrary, one of the major use cases for AMP devices is indoor positioning by using AMP devices as anchor points with known location. Therefore, it is reasonable to assume the location of some AMP devices are already known to the AP.

In some examples, most of the AMP devices are assumed to be fixed or with very low mobility. In such a case, the location of the AMP device can be reported to the AP only once when it is activated for the first time. Considering the extremely long service period, e.g., months or even years, the signaling overhead for location report is negligible.

With accurate location of AMP devices, grouping with much finer granularity can be done as illustrated in FIG. 2. As illustrated by FIG. 2, AMP devices within proximity of each other can be grouped and all the AMP devices associated with the AP can be divided into N groups. In some examples, the group size and the number of groups can be determined based on the overall number of associated AMP devices or the number of average active AMP devices per second. If this number is large, the collision probability is high and more groups is divided; or otherwise, less groups is divided. Such configurations can be either fixed or dynamically adjusted by the AP depending on the real time situation. Once the grouping is done, there are some options for medium access control.

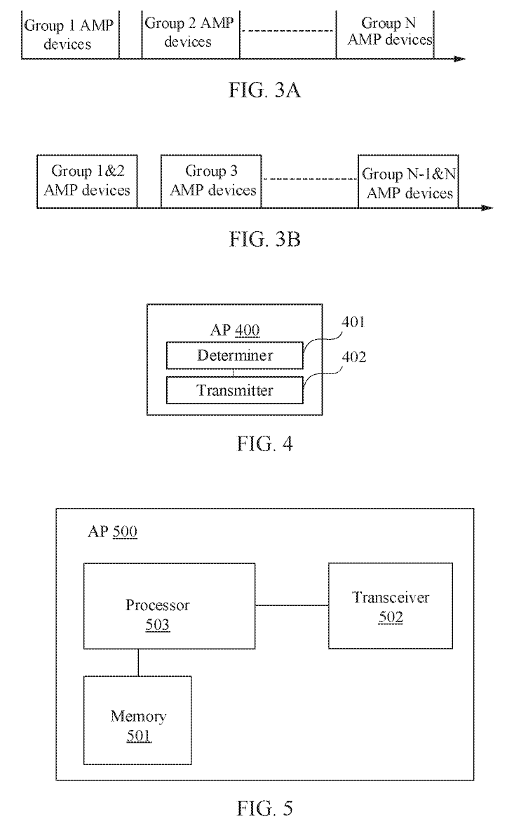

In an optional example, group channel access in different time intervals includes one group per time interval. In details, only one group is allowed to access the channel within one time interval as illustrated in FIG. 3A.

In another optional example, group channel access in different time intervals includes multiple groups per time interval. In details, multiple groups are allowed to access the channel within one time interval as illustrated in FIG. 3B. This optional example is more flexible. When some AMP devices belonging to the same group go to sleep in a particular time interval, the number of remaining active AMP devices gets small, and the channel access efficiency can be low. In such a case, when multiple groups are allowed to access the channel, the overall number of AMP devices accessing the channel can be maintained to the same level and the channel access efficiency keeps unchanged.

In some examples, the group configuration also depends on the percentage of AMP devices with known locations to the AP. It is noted that not all AMP devices can be grouped. Only those AMP devices with known locations can be grouped by the AP. The group size and the number of groups are also depended on the percentage of AMP devices with known locations. For example, for an AP with 3000 associated AMP devices, assuming location information of 95% of these AMP devices is known to the AP, the number of AMP devices without location information is 150. It means in each interval, in addition to the group with access allowance, up to 150 other AMP devices may also compete for the channel. In another case where the location information of only 50% of these AMP devices is assumed to be known to the AP, there could be up to 1500 AMP devices competing for the channel within each time interval. It is understood that the group size of the latter case is small to avoid collision.

It is noted that the proposed grouping can also mitigate the hidden node issue because as long as one AMP device is a hidden node to another AMP device, these AMP devices are unlikely to be in the same group thus may not transmit at the same time.

FIG. 4 illustrates an example of an AP 400 according to an embodiment of the present application. The AP 400 is configured to implement some embodiments of the disclosure. Some embodiments of the disclosure may be implemented into the AP 400 using any suitably configured hardware and/or software. The AP 400 includes includes a determiner 401 configured to determine a medium access control associated with ambient power (AMP) devices based on a location information associated with the AMP devices and a transmitter 402 configured to transmit the medium access control to at least one of the AMP devices. This can enhance a channel access efficiency, improve a collision issue, mitigate a hidden node issue, improve additional resource usage, and/or improve signaling overhead.

FIG. 5 illustrates an example of an AP 500 according to an embodiment of the present disclosure. The AP 500 is configured to implement some embodiments of the disclosure. Some embodiments of the disclosure may be implemented into the AP 500 using any suitably configured hardware and/or software. The AP 500 may include a memory 501, a transceiver 502, and a processor 503 coupled to the memory 501 and the transceiver 502. The processor 503 may be configured to implement proposed functions, procedures and/or methods described in this description. Layers of radio interface protocol may be implemented in the processor 503. The memory 501 is operatively coupled with the processor 503 and stores a variety of information to operate the processor 503. The transceiver 502 is operatively coupled with the processor 503, and the transceiver 502 transmits and/or receives a radio signal. The processor 503 may include application-specific integrated circuit (ASIC), other chipset, logic circuit and/or data processing device. The memory 501 may include read-only memory (ROM), random access memory (RAM), flash memory, memory card, storage medium and/or other storage device. The transceiver 502 may include baseband circuitry to process radio frequency signals. When the embodiments are implemented in software, the techniques described herein can be implemented with modules (e.g., procedures, functions, and so on) that perform the functions described herein. The modules can be stored in the memory 501 and executed by the processor 503. The memory 501 can be implemented within the processor 503 or external to the processor 503 in which case those can be communicatively coupled to the processor 503 via various means as is known in the art.

In some embodiments, the processor 503 is configured to determine a medium access control associated with ambient power (AMP) devices based on a location information associated with the AMP devices, and the transceiver 502 is configured to transmit the medium access control to at least one of the AMP devices. This can enhance a channel access efficiency, improve a collision issue, mitigate a hidden node issue, improve additional resource usage, and/or improve signaling overhead.

FIG. 6 is an example of a communication method 600 of medium access control performed by an AP according to an embodiment of the present disclosure. The communication method 600 of medium access control is configured to implement some embodiments of the disclosure. Some embodiments of the disclosure may be implemented into the communication method 600 of medium access control using any suitably configured hardware and/or software. In some embodiments, the communication method 600 of medium access control includes: an operation 602, determining, by an access point (AP), a medium access control associated with ambient power (AMP) devices based on a location information associated with the AMP devices, and an operation 604, transmitting, by the AP, the medium access control to at least one of the AMP devices. This can enhance a channel access efficiency, improve a collision issue, mitigate a hidden node issue, improve additional resource usage, and/or improve signaling overhead.

In some embodiments, the location information associated with the AMP devices includes locations and/or mobilities associated with the AMP devices. In some embodiments, the communication method of medium access control further includes acquiring, by the AP, the location information associated with the AMP devices from the at least one of the AMP devices or at least one network node knowing the location information associated with the AMP devices. In some embodiments, the medium access control includes a group configuration associated with the AMP devices and/or a channel access information associated with the AMP devices. In some embodiments, the group configuration associated with the AMP devices is fixed or dynamically adjusted, activated, or deactivated by the AP based on an overall number of associated AMP devices, a number of average active AMP devices per second, and/or a percentage of AMP devices with known locations. In some embodiments, an activation bit association with the group configuration is broadcasted in a beacon frame transmitted by the AP to the at least one of the AMP devices.

In some embodiments, the group configuration includes group identifiers (IDs) associated with the AMP devices, the group IDs are assigned and signaled by the AP to the AMP devices, or association IDs (AIDs) associated with the group IDs are assigned and signaled by the AP to the AMP devices based on a grouping rule. For example, all the AMP devices satisfying the condition AID mod N = i belong to the same group i. In some embodiments, the group IDs are contained in a physical layer (PHY) and/or medium access control (MAC) header of a frame transmitted by the AP to the AMP devices or in a frame body of the frame. In some embodiments, the channel access information includes a pre-fixed channel access or a dynamic channel access configuration. For pre-fixed channel access, the access time interval is defined based on the system timing. For example, the rule can be that 10 s is divided into 100 time intervals and group i is allowed to access channel only in the ith time interval. For dynamic channel access, the channel access information is signaled by the AP to the at least one of the AMP devices within each time interval for each group associated with the AMP devices dynamically. The channel access information indicates a group channel access in different time intervals. In some embodiments, one group is allowed to access a channel within one time interval, or multiple groups are allowed to access the channel within one time interval. In some embodiments, the medium access control associated with ambient power (AMP) devices is applied in an uplink random access (URA).

FIG. 7 illustrates an example of an AMP device 700 according to an embodiment of the present application. The AMP device 700 is configured to implement some embodiments of the disclosure. Some embodiments of the disclosure may be implemented into the AMP device 700 using any suitably configured hardware and/or software. The AMP device 700 includes includes a receiver 701 configured to receive from an access point (AP), a medium access control associated with the AMP devices, wherein the medium access control is associated with a location information associated with the AMP devices, and an executer 702 configured to perform channel access based on the medium access control. This can enhance a channel access efficiency, improve a collision issue, mitigate a hidden node issue, improve additional resource usage, and/or improve signaling overhead.

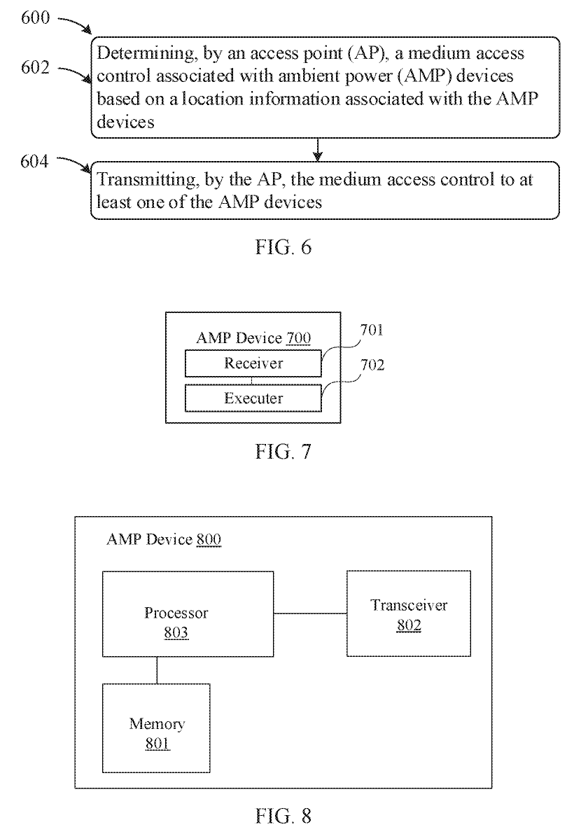

FIG. 8 illustrates an example of an AMP device 800 according to an embodiment of the present disclosure. The AMP device 800 is configured to implement some embodiments of the disclosure. Some embodiments of the disclosure may be implemented into the AMP device 800 using any suitably configured hardware and/or software. The AMP device 800 may include a memory 801, a transceiver 802, and a processor 803 coupled to the memory 801 and the transceiver 802. The processor 803 may be configured to implement proposed functions, procedures and/or methods described in this description. Layers of radio interface protocol may be implemented in the processor 803. The memory 801 is operatively coupled with the processor 803 and stores a variety of information to operate the processor 803. The transceiver 802 is operatively coupled with the processor 803, and the transceiver 802 transmits and/or receives a radio signal. The processor 803 may include application-specific integrated circuit (ASIC), other chipset, logic circuit and/or data processing device. The memory 801 may include read-only memory (ROM), random access memory (RAM), flash memory, memory card, storage medium and/or other storage device. The transceiver 802 may include baseband circuitry to process radio frequency signals. When the embodiments are implemented in software, the techniques described herein can be implemented with modules (e.g., procedures, functions, and so on) that perform the functions described herein. The modules can be stored in the memory 801 and executed by the processor 803. The memory 801 can be implemented within the processor 803 or external to the processor 803 in which case those can be communicatively coupled to the processor 803 via various means as is known in the art.

In some embodiments, the transceiver 802 is configured to receive from an access point (AP), a medium access control associated with the AMP devices, wherein the medium access control is associated with a location information associated with the AMP devices, and the processor 803 is configured to perform channel access based on the medium access control. This can enhance a channel access efficiency, improve a collision issue, mitigate a hidden node issue, improve additional resource usage, and/or improve signaling overhead.

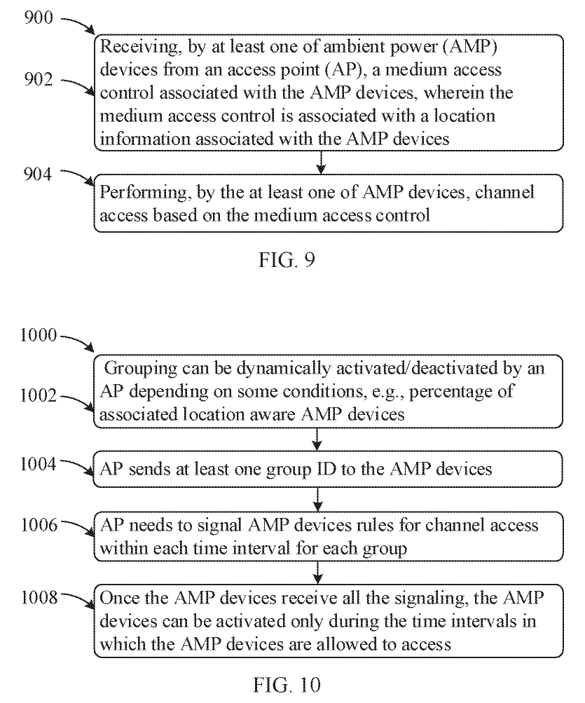

FIG. 9 is an example of a communication method 900 of medium access control performed by an AMP device according to an embodiment of the present disclosure. The communication method 900 of medium access control is configured to implement some embodiments of the disclosure. Some embodiments of the disclosure may be implemented into the communication method 900 of medium access control using any suitably configured hardware and/or software. In some embodiments, the communication method 900 of medium access control includes: an operation 902, receiving, by at least one of ambient power (AMP) devices from an access point (AP), a medium access control associated with the AMP devices, wherein the medium access control is associated with a location information associated with the AMP devices, and an operation 904, performing, by the at least one of AMP devices, channel access based on the medium access control. This can enhance a channel access efficiency, improve a collision issue, mitigate a hidden node issue, improve additional resource usage, and/or improve signaling overhead.

In some embodiments, the location information associated with the AMP devices includes locations and/or mobilities associated with the AMP devices. In some embodiments, the communication method of medium access control further includes transmitting, by the at least one of the AMP devices, the location information associated with the AMP devices to the AP. In some embodiments, the medium access control includes a group configuration associated with the AMP devices and/or a channel access information associated with the AMP devices. In some embodiments, the group configuration associated with the AMP devices is fixed or dynamically adjusted, activated, or deactivated by the AP based on an overall number of associated AMP devices, a number of average active AMP devices per second, and/or a percentage of AMP devices with known locations.

In some embodiments, an activation bit association with the group configuration is broadcasted in a beacon frame transmitted by the AP to the at least one of the AMP devices. In some embodiments, the group configuration includes group identifiers (IDs) associated with the AMP devices, the group IDs are assigned and signaled by the AP to the AMP devices, or association IDs (AIDs) associated with the group IDs are assigned and signaled by the AP to the AMP devices based on a grouping rule. In some embodiments, the group IDs are contained in a physical layer (PHY) and/or medium access control (MAC) header of a frame transmitted by the AP to the AMP devices or in a frame body of the frame. In some embodiments, the channel access information is signaled by the AP to the at least one of the AMP devices within each time interval for each group associated with the AMP devices. In some embodiments, the channel access information includes a pre-fixed channel access or a dynamic channel access configuration.

In some embodiments, the channel access information indicates a group channel access in different time intervals. In some embodiments, one group is allowed to access a channel within one time interval, or multiple groups are allowed to access the channel within one time interval. In some embodiments, the medium access control associated with ambient power (AMP) devices is applied in an uplink random access (URA). In some embodiments, the at least one of the AMP devices is activated during at least one time interval in which the at least one of the AMP devices is allowed to access.

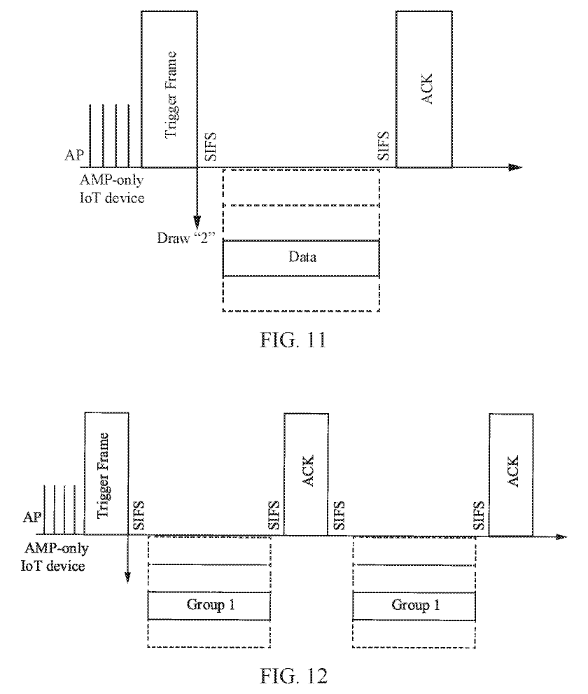

FIG. 10 illustrates a communication method 1000 of medium access control regarding signaling procedure according to an embodiment of the present disclosure. FIG. 10 illustrates that, in some embodiments, the communication method 1000 of medium access control regarding signaling procedure includes at least one of following operations:

Some embodiments assume that the location of each AMP device can either be actively reported by the device when it is installed or activated for the first time, or the AMP devices can be positioned in real time manner by the other network nodes including AP, user equipment (UE), and/or other AMP devices, etc.

Operation 1002: Grouping can be dynamically activated/deactivated by an AP depending on some conditions (the aforementioned conditions), e.g., percentage of associated location aware AMP devices. This activation bit can be broadcasted in a beacon frame to all the associated AMP devices. The beacon frame may be transmitted by the AP to the associated AMP devices.

Operation 1004: The AP sends at least one group ID to the AMP devices. For example, this signaling can happen any time after the location of the AMP devices is known to the AP, e.g., association frame, and/or data frame, etc. Two optional examples can be considered.

Optional example 1: Explicit group ID where the AP assigns and signals the ID to the AMP device. For explicit group ID signaling, the ID can be contained either in the PHY/MAC header or in the frame body.

Optional example 2: Implicit group ID where the AP assigns AID for each AMP device based on certain grouping rules, e.g., all the AMP devices satisfying the below condition belong to the same group i.

AID mod N = i

By doing this, the AMP devices are implicitly grouped according to its AID. The implicit group ID reduce signaling overhead.

Operation 1006: The AP also needs to signal the AMP devices the rules for channel access within each time interval for each group, which can be done with two optional examples as follows.

Optional example 1: Pre-fixed channel access. The time interval is defined based on the system timing. Once the AMP devices are synchronized with AP using timestamp, they can be assigned to one time interval based on the pre-fixed rules. For example, the rule can be that 10 s is divided into 100 time interval and group i is allowed to access channel only in the first time interval.

Optional example 2: Dynamic configuration. The AP needs to signal each AMP device group exact time interval for channel access and such signaling may at least include information such as duration, and/or period, etc.

Operation 1008: Once the AMP devices receive all the signaling, the AMP devices can be activated only during the time intervals in which the AMP devices are allowed to access.

It is noted that in addition to the location, AMP devices may also need to report its mobility since change to location may jeopardize the grouping. For example, the location information may include locations and/or mobilities of the AMP devices.

FIG. 11 illustrates uplink orthogonal frequency-division multiple access (OFDMA) random access (UORA) in IEEE 802.11ax. In some embodiments, the proposed grouping can be combined with any available channel access mechanism to further enhance the medium access efficiency. For example, in 802.11ax uplink OFDMA random access (UORA) is proposed where each resource unit (RU) can be randomly selected by STA as illustrated in FIG. 11.

FIG. 12 illustrates uplink random access (URA) mechanism according to an embodiment of the present disclosure. Because each STA randomly chooses one RU, collision can happen with large number of STAs. For AMP networks, each RU can correspond to one channel since OFDMA cannot be supported by AMP device. However, the principle of UORA can still be used with each RU replaced by one channel. Such uplink random access (URA) mechanism can be integrated with grouping as illustrated in FIG. 12. In the end, for example, the additional resource usage and signaling overhead can be negligible in a multi-purpose AMP deployment supporting at least positioning.

### Use Cases

In some embodiments, some use cases can implement the AP 400 of FIG. 4, the AP 500 of FIG. 5, the communication method 600 of medium access control performed by the AP of FIG. 6, the AMP device 700 of FIG. 7, the AMP device 800 of FIG. 8, the communication method 900 of medium access control performed by the AMP device of FIG. 9, and/or the communication method 1000 of medium access control regarding signaling procedure of FIG. 10 using any suitably configured hardware and/or software. The use case may include alt least one of the following:

### Use Case 1: Smart Manufacturing

Smart manufacturing plays a critical role in increasing productivity and improving sustainability. The key to smart manufacturing is inter-connectivity and inter-operability between assets, storage tanks, materials and other passive objects in factories or industrial areas, enabled by wireless identification and sensing. In smart manufacturing, identification is an essential service mainly for asset management and worker tracking, where labels can be attached to human beings or assets including production materials, storage tanks, containers, etc. The following functionalities can be provided:

Inventory check: once tags are read remotely, the ID of the item to which the tag is attached can be acquired and traced as well as the information associated with the ID, e.g., position, product number, etc. Such information can then be further used for other purpose, e.g., supply chain management, anti-counterfeiting, etc.

Attendance check: once a worker enters or leaves a specific area of a factory or a working spot, the tag attached to him can be read and attendance can be automatically checked.

Real-time inspection and tracing: a product can be assembled and moved along multiple steps in a line of machines and workers. Real-time inspection and tracing are needed to guarantee that each machine or worker, that is performing a particular job must finish the job before the product moves to the next step in the production line.

Environmental sensing and monitoring are needed to collect real-time temperature and humidity information for production lines, computing and data centres and other equipment. The weight and moving speed of a product in a production line can be collected via motion and pressure detection sensors. In addition, to maintain safety within a factory, gas leakage in gas tanks and pipelines can also be detected by such sensing networks. This use case requires ultra-small size, ultra-low cost and power consumption labels so that they can be deployed in a very high density. In addition, the battery-less devices can enable maintenance-free operation.

### Use Case 2: Data Center

The data center is the bedrock of modern ICT infrastructure, running software and processing data. The management network is essential to improve the reliability and efficiency, thus guaranteeing the safe and reliable operating conditions. Data centers are unique from all other building types, which need to be managed intelligently and comprehensively with the following functionalities:

Environmental monitoring to capture data on temperature, pressure, humidity and air flow etc., and highlight potential inefficiencies.

Facility monitoring to provide visibility into the entire power chain from aa generator down to a specific outlet on an intelligent cabinet power unit, and diagnose potential facility problems.

Asset management to maintain a centralized database that houses all of the IT and facility asset information including where the asset is located and how it is connected to other assets.

### Use Case 3: Logistics/Warehouse

In logistics, an inventory check is needed to view all products and identify any missing assets and discrepancies within the inventory. Packages are stored in containers such as cartons and the cartons are normally piled in a warehouse. A pile of cartons in a single storage location can be more than 10 m long and up to 8 m high.

In sorting systems the following functionalities maybe provided:

Accurate label identification for closely adjacent items on the conveyor system.

Fast label identification of the items on the conveyor belt that moves at a speed of 1.5-2 m/s.

Real-time monitoring and related information acquisition for the items on the conveyor system.

Environmental monitoring of temperature, humidity, etc. for specific items such as cold-chain transportation goods.

### Use Case 4: Smart Home

In a smart home, many devices such as smartphones, tablets, door locks, thermostats, home monitors, etc. are connected with each other. Low energy consumption and maintenance-free devices can be used for sensing and monitoring. For home environment sensing, such as temperature, humidity, etc., once the sensed information is collected by a controlling node, the heater, air-conditioner and (de)humidifier can be switched on/off automatically accordingly to adjust the temperature and humidity to a comfortable level. Such devices can also be used for home safety. For example, once gas leakage happens, a gas detector can send an alert to warn the home owner. Similarly, if a smoke detector senses there is a fire, it can automatically send the alert. In addition, motion detector is needed to detect the intruders and send alert to the home owner. Another important functionality needed is to locate keys, wallets and other personal belongs with attached labels.

### Use Case 5: Smart Agriculture

Smart agriculture focuses on providing the industry with the infrastructure to leverage advanced technology for tracking, monitoring, automating and analyzing operations. Similar to smart home, low energy consumption and maintenance-free devices can be used for sensing and monitoring, such as monitoring of soil moisture, soil fertility, temperature, wind speed, plant growth etc. For example, once the soil moisture is sensed, the irrigation system can be controlled to increase or decrease the supply of water to land or crops. Asset management for agricultural facilities can also be done by reading the labels attached to those facilities remotely.

### Use Case 6: Indoor Positioning

For indoor positioning, reference tags with known location can be densely deployed indoor to establish a navigating and positioning system that has a wide range of potential applicable venues such as giant shopping malls, parking, smart factories, warehouses, etc. Shopping centers offer a wide range of services and products, including large supermarkets, a collection of retail stores, restaurants, banks, theatres, fitness and leisure facilities, underground parking areas, professional offices and other establishments. Many giant shopping centers have been established all over the world, each can occupy an area of tens to hundreds of thousands m², composed of one or multiple buildings, each of which has multiple-story both over and underground. While enjoy various services, people often have troubles in finding a vacant parking spot or his/her own car, a target shop/restaurant or a target item in a supermarket. The reference tags can be evenly distributed with high density, e.g., 2-meter intervals, within the entire shopping center on each floor and in each room. Indoor positioning can be enabled by a handheld device (e.g., smartphone), which can communicate with the reference tags.

### Use Case 7: Smart Power Grid

Sub-station plays a vital role in the electrical power system to guarantee the continuity of the electrical power supply. It is deployed as transmission sub-station and distribution sub-station and one sub-station covers around 50000 m² service area. The sub-stations transform voltage from high to low, or the reverse, or perform some other important functions. Massive number of sensors and meters need to be deployed all over the sub-stations to monitor and report temperature, humidity, etc. Another important part of electrical power system is high voltage transmission lines that deliver electricity over long distances to reduce the amount of energy lost during the distance. Sensing and monitoring of high voltage transmission lines and towers can help to detect operation faults such as power leakage, tower tilting, etc. Such operation faults not only will stop the power supply, leading to large scale blackout, they might also cause damage to the very expensive equipment. Since many sensors and meters need to be deployed in the inaccessible locations, they need to be maintenance free and ideally battery-less to support long life span.

### Use Case 8: Fresh Food Supply Chain

In this use case, a large food supplier monitors its food supply chain by adding a simple and small form factor device (sticker) on to each of the Reusable Transport Item (RTIs) used for storing and transporting of the food.

In some embodiments, the AMP device 700 of FIG. 7 and/or the AMP device 800 of FIG. 8 may be an AMP IoT device. In some examples, the AMP IoT device may be an AMP-only IoT device or an AMP-assisted IoT device.

### AMP-only IoT device

For AMP-only IoT device, the potential functional requirements include:

Supported operation band: It may be helpful to achieve low complexity and low power consumption by lower frequency band. This is due to its small channel bandwidth and good propagation property in lower frequency band. Therefore, sub 1GHz shall be considered with high priority. The 2.4GHz can also be considered since it is the mature frequency band widely used.

Constraints of power consumption: Since ambient power is used and energy harvester with small size can be utilized due to the small size restriction of the device, the power can be harvested is very limited. Therefore, ultra-low power consumption, e.g., less than 1 mW can be considered as the design target for AMP IoT.

Coexistence: Irrespective of sub1GHz or 2.4GHz, AMP-only IoT device will share same frequency band(s) with legacy WiFi devices. Therefore, backward compatibility and coexistence with legacy devices shall be supported. The regulation of these frequency band(s) shall be followed.

Support energy harvesting: In order to achieve battery-less (i.e., not using conventional battery), it will use ambient power to drive itself and to communicate with the AP. Therefore, energy harvesting should be supported by the AMP-only devices. For different use cases, different ambient power may be available thus different energy harvester can be supported based on the suitable ambient power for a specific use case.

Coverage: As discussed in the use cases and requirements in the above embodiments, up to 30 m for indoor scenario and up to 100 m for outdoor scenario are required.

### AMP-assisted IoT device

The potential functional requirements for AMP-assisted IoT device include:

Supported operation band: With similar capabilities to the current Wi-Fi devices, it is easy for an AMP-assisted IoT device to operate on the current frequency bands such as 2.4GHz and sub 1GHz. For example, if it is optimized in addition to the 802.11ah devices using sub 1GHz, the AMP-assisted IoT device can also use sub 1GHz to support energy harvesting.

In order to achieve maintenance free operation, it may use ambient power to sustain itself and to communicate with the AP. In order to fulfill the required higher power consumption compared with that of AMP-only devices, the energy harvester shall be able to provide a higher output power, e.g., more than 10 mWs.

Coverage: Similar coverage as the current Wi-Fi devices can be expected, e.g., up to 30m for indoor case and up to 200m for outdoor case (note that for 802.11ah, it can be up to 1km).

Commercial interests for some embodiments are as follows. 1. Enhancing a channel access efficiency. 2. Improving a collision issue. 3. Mitigating a hidden node issue. 4. Improving additional resource usage. 5. Improving signaling overhead. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as AMP tag based communication systems. Compatible products follow at least one proposed solution, method, system, and apparatus of some embodiments of the present disclosure. The proposed solution, method, system, and apparatus are widely used in AMP related products, AP related products, and/or communication systems. With the implementation of the at least one proposed solution, method, system, and apparatus of some embodiments of the present disclosure, at least one modification to methods and apparatus of location aware medium access for AMP devices are considered for standardizing.

In summary, AMP device is a huge market in many scenarios, such as smart home, smart manufacturing, logistics/warehouse, etc. AMP devices opens a whole new market due to its ultra-low cost and maintenance free features. Some embodiments of the present disclosure can be used when cost efficient, maintenance free and high accuracy AMP device is needed and the interested group include AMP IoT device vendors, companies running large shopping malls, warehouse/logistics companies, and smart home service providers. Some embodiments of the present disclosure are a technique/process that can be applied to AMP tag based communication systems. Some embodiments of the present disclosure propose accurate location aware grouping methods to enhance the channel access efficiency by reducing the collision probability. It can also mitigate the hidden node problem. The additional resource usage and signaling overhead can be negligible in a multi-purpose AMP deployment supporting at least positioning.

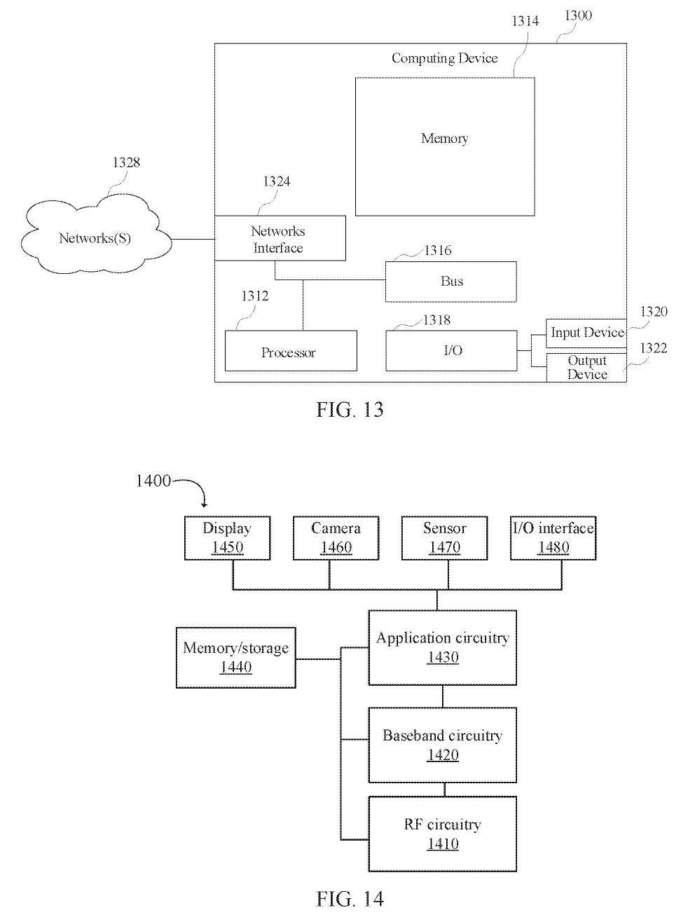

FIG. 13 is an example of a computing device 1300 according to an embodiment of the present disclosure. Any suitable computing device can be used for performing the operations described herein. For example, FIG. 13 illustrates an example of the computing device 1300 that can implement the AP 400 of FIG. 4, the AP 500 of FIG. 5, the communication method 600 of medium access control performed by the AP of FIG. 6, the AMP device 700 of FIG. 7, the AMP device 800 of FIG. 8, the communication method 900 of medium access control performed by the AMP device of FIG. 9, and/or the communication method 1000 of medium access control regarding signaling procedure of FIG. 10 using any suitably configured hardware and/or software. In some embodiments, the computing device 1300 can include a processor 1312 that is communicatively coupled to a memory 1314 and that executes computer-executable program code and/or accesses information stored in the memory 1314. The processor 1312 may include a microprocessor, an application-specific integrated circuit (“ASIC”), a state machine, or other processing device. The processor 1312 can include any of a number of processing devices, including one. Such a processor can include or may be in communication with a computer-readable medium storing instructions that, when executed by the processor 1312, cause the processor to perform the operations described herein.

The memory 1314 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1300 can also include a bus 1316. The bus 1316 can communicatively couple one or more components of the computing device 1300. The computing device 1300 can also include a number of external or internal devices such as input or output devices. For example, the computing device 1300 is illustrated with an input/output (“I/O”) interface 1318 that can receive input from one or more input devices 1320 or provide output to one or more output devices 1322. The one or more input devices 1320 and one or more output devices 1322 can be communicatively coupled to the I/O interface 1318. The communicative coupling can be implemented via any suitable manner (e.g., a connection via a printed circuit board, connection via a cable, communication via wireless transmissions, etc.). Non-limiting examples of input devices 1320 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1322 include a liquld crystal display (LCD) screen, an external monitor, a speaker, or any other device that can be used to display or otherwise present outputs generated by a computing device.

The computing device 1300 can execute program code that configures the processor 1312 to perform one or more of the operations described above with respect to FIGS. 4-12. The program code may be resident in the memory 1314 or any suitable computer-readable medium and may be executed by the processor 1312 or any other suitable processor.

The computing device 1300 can also include at least one network interface device 1324. The network interface device 1324 can include any device or group of devices suitable for establishing a wired or wireless data connection to one or more data networks 1328. Non limiting examples of the network interface device 1324 include an Ethernet network adapter, a modem, and/or the like. The computing device 1300 can transmit messages as electronic or optical signals via the network interface device 1324.

FIG. 14 is a block diagram of an example of a communication system 1400 according to an embodiment of the present disclosure. Embodiments described herein may be implemented into the communication system 1400 using any suitably configured hardware and/or software. FIG. 14 illustrates the communication system 1400 including a radio frequency (RF) circuitry 1410, a baseband circuitry 1420, an application circuitry 1430, a memory/storage 1440, a display 1450, a camera 1460, a sensor 1470, and an input/output (I/O) interface 1480, coupled with each other at least as illustrated.

The application circuitry 1430 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1400 can execute program code that configures the application circuitry 1430 to perform one or more of the operations described above with respect to FIGS. 4-12. The program code may be resident in the application circuitry 1430 or any suitable computer-readable medium and may be executed by the application circuitry 1430 or any other suitable processor.

The baseband circuitry 1420 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1420 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1410 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1410 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the AP 400 of FIG. 4, the AP 500 of FIG. 5, the AMP device 700 of FIG. 7, or the AMP device 800 of FIG. 8 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1440 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1480 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1470 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1450 may include a display, such as a liquid crystal display and a touch screen display. In various embodiments, the communication system 1400 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A communication method of medium access control, comprising:
determining, by an access point (AP), a medium access control associated with ambient power (AMP) devices based on a location information associated with the AMP devices; and
transmitting, by the AP, the medium access control to at least one of the AMP devices.

2. The communication method of medium access control according to claim 1, wherein the location information associated with the AMP devices comprises locations and/or mobilities associated with the AMP devices.

3. The communication method of medium access control according to claim 1, further comprising acquiring, by the AP, the location information associated with the AMP devices from the at least one of the AMP devices or at least one network node knowing the location information associated with the AMP devices.

4. The communication method of medium access control according to claim 1, wherein the medium access control comprises a group configuration associated with the AMP devices and/or a channel access information associated with the AMP devices.

5. The communication method of medium access control according to claim 1, wherein the group configuration comprises group identifiers (IDs) associated with the AMP devices, the group IDs are assigned and signaled by the AP to the AMP devices, or association IDs (AIDs) associated with the group IDs are assigned and signaled by the AP to the AMP devices based on a grouping rule.

6. The communication method of medium access control according to claim 5, wherein the group IDs are contained in a physical layer (PHY) and/or medium access control (MAC) header of a frame transmitted by the AP to the AMP devices or in a frame body of the frame.

7. The communication method of medium access control according to claim 4, wherein the channel access information is signaled by the AP to the at least one of the AMP devices within each time interval for each group associated with the AMP devices.

8. An access point (AP), comprising:
a memory; a transceiver; and a processor coupled to the memory and the transceiver;
wherein the processor is configured to execute computer-executable instructions stored in the memory to perform operations of:
determining a medium access control associated with ambient power (AMP) devices based on a location information associated with the AMP devices; and
transmitting, via the transceiver, the medium access control to at least one of the AMP devices.

9. The AP according to claim 8, wherein the location information associated with the AMP devices comprises locations and/or mobilities associated with the AMP devices.

10. The AP according to claim 8, wherein the processor is configured to execute computer-executable instructions stored in the memory to further perform an operation of: acquiring the location information associated with the AMP devices from the at least one of the AMP devices or at least one network node knowing the location information associated with the AMP devices.

11. The AP according to claim 8, wherein the medium access control comprises a group configuration associated with the AMP devices and/or a channel access information associated with the AMP devices.

12. The AP according to claim 8, wherein the group configuration comprises group identifiers (IDs) associated with the AMP devices, the group IDs are assigned and signaled by the AP to the AMP devices, or association IDs (AIDs) associated with the group IDs are assigned and signaled by the AP to the AMP devices based on a grouping rule.

13. The AP according to claim 12, wherein the group IDs are contained in a physical layer (PHY) and/or medium access control (MAC) header of a frame transmitted by the AP to the AMP devices or in a frame body of the frame.

14. The AP according to claim 11, wherein the channel access information indicates a group channel access in different time intervals.

15. An ambient power (AMP) device, comprising:
a memory; a transceiver; and a processor coupled to the memory and the transceiver;
wherein the processor is configured to execute computer-executable instructions stored in the memory to perform operations of:
receiving, via the transceiver from an access point (AP), a medium access control associated with the AMP devices, wherein the medium access control is associated with a location information associated with the AMP devices; and
performing channel access based on the medium access control.

16. The AMP device according to claim 15, wherein the location information associated with the AMP devices comprises locations and/or mobilities associated with the AMP devices.

17. The AMP device according to claim 15, wherein the processor is configured to execute computer-executable instructions stored in the memory to further perform an operation of: transmitting, via the transceiver, the location information associated with the AMP devices to the AP.

18. The AMP device according to claim 15, wherein the medium access control comprises a group configuration associated with the AMP devices and/or a channel access information associated with the AMP devices.

19. The AMP device according to claim 15, wherein the group configuration comprises group identifiers (IDs) associated with the AMP devices, the group IDs are assigned and signaled by the AP to the AMP devices, or association IDs (AIDs) associated with the group IDs are assigned and signaled by the AP to the AMP devices based on a grouping rule.

20. The AMP device according to claim 19, wherein the group IDs are contained in a physical layer (PHY) and/or medium access control (MAC) header of a frame transmitted by the AP to the AMP devices or in a frame body of the frame.
